(19) United States
(12) Patent Application Publication
(10) Pub. No.: US 2024/0311814 A1
(43) Pub. Date: Sep. 19, 2024

(54) RETAIL METHODS AND SYSTEMS

(71) Applicant: MICHEL VEILLEUX, OTTAWA (CA)

(72) Inventor: MICHEL VEILLEUX, OTTAWA (CA)

(21) Appl. No.: 18/671,210

(22) Filed: May 22, 2024

Related U.S. Application Data
(63) Continuation of application No. 17/891,527, filed on Aug. 19, 2022, now abandoned.
(60) Provisional application No. 63/234,897, filed on Aug. 19, 2021.

(51) Int. Cl. G06Q 20/38; G06Q 30/0601

(52) U.S. Cl. CPC G06Q 20/385; G06Q 30/0639

(57) ABSTRACT

Portable electronic devices have become ubiquitous to a large portion of the human population globally. However, retailers at this point have not established systems that allow them to truly leverage these portable electronic devices to provide their guests with increased interaction within the guest management service and/or product provisioning as well as integrating these interactions into the retailers guest management chain. Systems and methods are outlined that reflect the real time instantaneous power of guest messaging to provide real time instantaneous interactions for the guest and retailer. These systems also support high volume guest management operations in a single coherent system to enhance the guest's experience, increase referrals or repeat business, expedite guest-retailer interactions and lower operating costs for the retailer.

### CROSS-REFERENCE TO RELATED APPLICATIONS

This patent application claims the benefit of priority (as a Continuation) from U.S. Non-Provisional patent application Ser. No. 17/891,527 (filed Aug. 19, 2022), which itself claims the benefit of priority from U.S. Provisional Patent Application No. 63/234,897 (filed Aug. 19, 2021), the entire contents of which are incorporated herein by reference.

### FIELD OF THE INVENTION

This patent application relates to event management and more particularly to leveraging wireless devices to increase customer engagement, increase and improve customer orientated service provisioning and automate aspects of service provisioning.

### BACKGROUND OF THE INVENTION

Retailing can be viewed as covering a wide range of activities from providing products and services to customers, to managing the staff and infrastructure for provision products and services, through to customer feedback, social media and data analytics.

Physical retailers can vary from a pop-up food stall with a few customers through single or multi-location bricks-and-mortar environments to sports arenas handing thousands or tens of thousands of customers per event. Whilst a variety of software applications exist to target many aspects of retailing such as payroll, invoicing, payment processing for retailers at any scale those relating to retail logistics, supply chain management etc. tend to be directed to multi-location environments. Further, many retailers only directly manage part of their activities relying on external partners to manage the remaining elements. These external services require that the retailer offset these additional costs either into increased pricing or reduced margins.

However, there are a massive number of retailers where small margins and/or customer pricing expectations limit the retailers ability to pass on these costs and for whom all of these additional external relationships cost time and effort to manage. Further, for a retailer operating in a regular mode periodically scaling their operations to host events can be a burden that acts as a barrier to them. For example, wedding venues have become a dedicated market segment due to their requirements of catering to large numbers of guests regularly within narrow time frames which are very different to those of a restaurant for example which may serve as many guests but over the course of a day or couple of days.

Accordingly, it would be beneficial to provide retailers with a software based system that allowed them to manage both their regular day to day customer side operations (what we will refer to as guest management) but also handle high or higher volume guest management operations allow the retailer to manage both in a single coherent manner. Further, within this specification we will refer to a guest rather than a customer.

Further, retailer reputation or what was once called “word of mouth” is critical for many retailers. Whilst the traditional oral recommendations or cautionary tales still occur these have been augmented by social media on multiple portable electronic devices where a single customer comment can be read by tens, hundreds, thousands of potential customers and through the persistence of digital footprints exist forever essentially where rather than being lost they become old or just part of the overall deluge of comments/reviews etc. Further, these social media posts are essentially instantaneous and can be made real time during the guest's experience of the retailers guest management activities.

Accordingly, it would be beneficial to provide retailers with an ability to leverage these portable electronic devices to provide the guests with increased interaction within the guest management service and/or product provisioning as well as integrating the guest management chain into a single application. Accordingly, reflecting the real time instantaneous power of guest messaging the embodiments of the invention provide real time instantaneous interactions for the guest and retailer. In addition to seeking to increase guest approval either leading to improved ratings, referrals or repeat business the application within other aspects of embodiments of the invention seeks to expedite guest-retailer interactions and lower the operating costs of the retailer.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to event management and more particularly to leveraging wireless devices to increase customer engagement, increase and improve customer orientated service provisioning and automate aspects of service provisioning.

In accordance with an embodiment of the invention there is provided a method comprising providing a user with a unique one time machine readable code (code) with respect to an order for
at least one of a product and a service;
   providing the at least one of the product and the service to the user in dependence upon the user presenting the code to a reader and successful validation of the code;
   automatically terminating the code upon successful validation of the code; and
   completing a financial transaction to a predetermined point in dependence upon successful validation of the code.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary network environment within which configurable electrical devices according to and supporting embodiments of the invention may be deployed and operate; and

FIG. 2 depicts an exemplary wireless portable electronic device supporting communications to a network such as depicted in FIG. 1 and configurable electrical devices according to and supporting embodiments of the invention;

FIG. 3 depicts an exemplary flow for an omnichannel system according to an embodiment of the invention;

FIG. 4 depicts an exemplary flow for an event registration portion of an omnichannel system according to an embodiment of the invention;

FIG. 5 depicts an exemplary flow for item purchasing and collection within an omnichannel system according to an embodiment of the invention;

FIG. 6 depicts an exemplary flow for an omnichannel system according to an embodiment of the invention;

FIG. 7 depicts an exemplary guest registration process for an omnichannel system according to an embodiment of the invention; and

FIG. 8 depicts exemplary graphical user interfaces (GUI) presented to a guest upon an event ending or a guest leaving an event by an omnichannel system according to an embodiment of the invention; and

FIG. 9 depicts an exemplary hierarchy of profiles associated with a guest/user within an omnichannel system according to an embodiment of the invention.

### DETAILED DESCRIPTION

The present invention is directed to event management and more particularly to leveraging wireless devices to increase customer engagement, increase and improve customer orientated service provisioning and automate aspects of service provisioning.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “wireless standard” as used herein and throughout this disclosure, refer to, but is not limited to, a standard for transmitting signals and/or data through electromagnetic radiation which may be optical, radio-frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

A “guest” as used herein may refer to, but is not limited to, a user who is provided with one or more products and/or services during an event. Whilst the guest may be providing a financial instrument with respect to payment for the one or more products and/or services during the event it would be evident to one of skill in the art that the embodiments of the invention presented and described do not rely upon a financial transaction or financial instrument to achieve the provisioning of the one or more products and/or services during an event.

An “event” as used herein may refer to, but is not limited to, something which happens or takes place. This may include, but not be limited to, a ceremony, a convention, a meeting, a festival, a concert, a happening, a media event, a party, a sporting event, a scheduled activity, and an unscheduled activity.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein, and throughout this disclosure, refers to a computer and/or microprocessor readable data file comprising data relating to settings and/or limits of an adult device. Such profiles may be established by a manufacturer/supplier/provider of a device, service, etc. or they may be established by a user through a user interface for a device, a service or a PED/FED in communication with a device, another device, a server or a service provider etc.

A “computer file” (commonly known as a file) as used herein, and throughout this disclosure, refers to a computer resource for recording data discretely in a computer storage device, this data being electronic content. A file may be defined by one of different types of computer files, designed for different purposes. A file may be designed to store electronic content such as a written message, a video, a computer program, or a wide variety of other kinds of data. Some types of files can store several types of information at once. A file can be opened, read, modified, copied, and closed with one or more software applications an arbitrary number of times. Typically, files are organized in a file system which can be used on numerous different types of storage device exploiting different kinds of media which keeps track of where the files are located on the storage device(s) and enables user access. The format of a file is defined by its content since a file is solely a container for data, although, on some platforms the format is usually indicated by its filename extension, specifying the rules for how the bytes must be organized and interpreted meaningfully. For example, the bytes of a plain text file are associated with either ASCII or UTF-8 characters, while the bytes of image, video, and audio files are interpreted otherwise. Some file types also allocate a few bytes for metadata, which allows a file to carry some basic information about itself.

“Metadata” as used herein, and throughout this disclosure, refers to information stored as data that provides information about other data. Many distinct types of metadata exist, including but not limited to, descriptive metadata, structural metadata, administrative metadata, reference metadata and statistical metadata. Descriptive metadata may describe a resource for purposes such as discovery and identification and may include, but not be limited to, elements such as title, abstract, author, and keywords. Structural metadata relates to containers of data and indicates how compound objects are assembled and may include, but not be limited to, how pages are ordered to form chapters, and typically describes the types, versions, relationships and other characteristics of digital materials. Administrative metadata may provide information employed in managing a resource and may include, but not be limited to, when and how it was created, file type, technical information, and who can access it. Reference metadata may describe the contents and quality of statistical data whereas statistical metadata may also describe processes that collect, process, or produce statistical data. Statistical metadata may also be referred to as process data.

An “artificial intelligence system” (referred to hereafter as artificial intelligence, AI) as used herein, and throughout disclosure, refers to machine intelligence or machine learning in contrast to natural intelligence. An AI may refer to analytical, human inspired, or humanized artificial intelligence. An AI may refer to the use of one or more machine learning algorithms and/or processes. An AI may employ one or more of an artificial network, decision trees, support vector machines, Bayesian networks, and genetic algorithms. An AI may employ a training model or federated learning.

“Machine Learning” (ML) or more specifically machine learning processes as used herein refers to, but is not limited, to programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an AI may include, but not be limited to, supervised learning, unsupervised learning, cluster analysis, reinforcement learning, feature learning, sparse dictionary learning, anomaly detection, association rule learning, inductive logic programming.

A “graphical user interface” (GUI) as employed herein may refer to, but is not limited to, a user interface that allows users to interact with electronic devices through graphical icons and audio indicator such as primary notation, instead of text-based user interfaces, typed command labels or text navigation. The actions in a GUI being usually performed through direct manipulation of the graphical elements that form part of the GUI rendered upon a display of an electronic device such as a PED or FED for example.

An “omnichannel system” as used herein may refer to, but is not limited to, one or more of a software application, a method and a system providing a centralized guest management experience to a guest from initial event communications and/or registration, through to event specific activities during the event, and post-event activities. Within embodiments of the invention described below such an omnichannel system is described within the context of an Omnichannel Guest Management (OGL) System, Application and Platform (OGL-SAP) where a guest may exploit the application directly and therein the system/platform just as an event venue, event manager etc. may exploit an application (which may be the same application or a different application) to establish settings, rules, content, menus, events, etc. and therein access/interact with the system/platform.

A “machine readable code” as used herein may refer to, but is not limited to, a visual code which presents data in a barcode or Quick Response (QR) code, an encrypted packet of digital data, an encrypted element of digital content, a packet of digital data, or an item of digital content.

A “barcode” as used herein may refer to, but is not limited to, a representation of data as a series of parallel lines with varying the widths and spacings. Such linear or one-dimensional (1D) barcodes can be read by optical scanners or processing of an image acquired with a camera.

A “QR code” as used herein may refer to, but is not limited to, a matrix barcode or two-dimensional (2D) barcode using a pattern of dots, rectangles, hexagons etc. Such 2D barcodes can be read by image processing of an image acquired with a camera.

Whilst the embodiments of the invention are described and depicted with respect to what may be referred to as high volume guest management their principles apply equally to small volume and very high volume guest management.

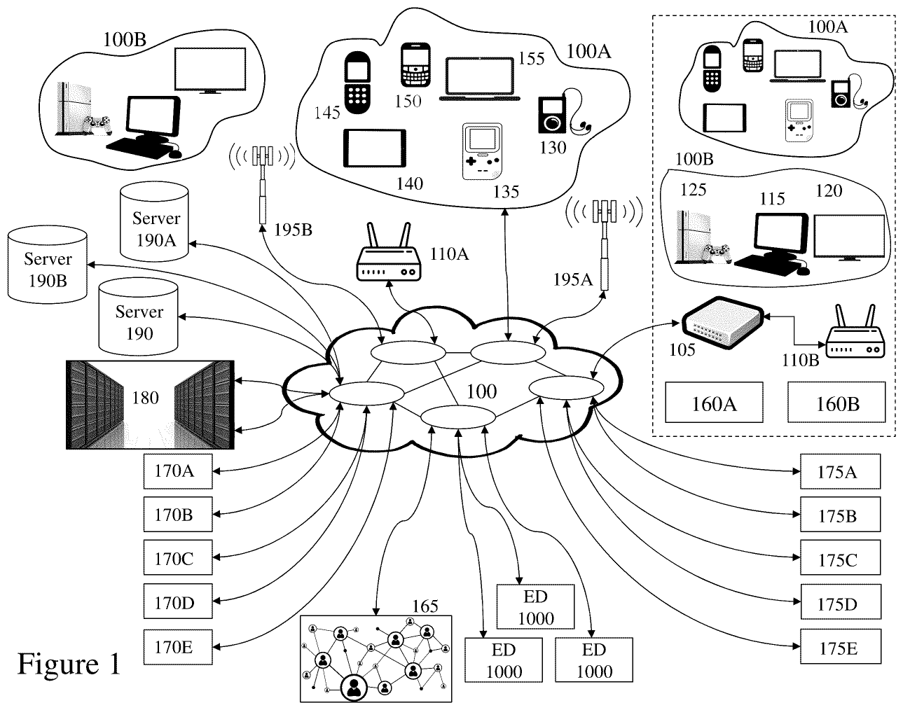

Referring to FIG. 1 there is depicted a Network 100 within which embodiments of the invention may be employed supporting Omnichannel Guest Management (OGL) Systems, Applications and Platforms (OGL-SAPs) according to embodiments of the invention. Such OGL-SAPs, for example, supporting multiple communication channels, dynamic filtering, etc. As shown first and second user groups 100A and 100B respectively interface to a telecommunications Network 100. Within the representative telecommunication architecture, a remote central exchange 180 communicates with the remainder of a telecommunication service providers network via the Network 100 which may include for example long-haul OC-48/OC-192 backbone elements, an OC-48 wide area network (WAN), a Passive Optical Network, and a Wireless Link. The central exchange 180 is connected via the Network 100 to local, regional, and international exchanges (not shown for clarity) and therein through Network 100 to first and second cellular APs 195A and 195B respectively which provide Wi-Fi cells for first and second user groups 100A and 100B respectively. Also connected to the Network 100 are first and second Wi-Fi nodes 110A and 110B, the latter of which being coupled to Network 100 via router 105. Second Wi-Fi node 110B is associated with Guest Event Provider 160, e.g. Overflow Brewery Company (hereinafter Overflow), comprising other first and second user groups 100A and 100B. Second user group 100B may also be connected to the Network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130.

Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the Network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the Network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 or Bluetooth as well in an ad-hoc manner.

Also connected to the Network 100 are Social Networks (SOCNETS) 165, first and second service providers 170A and 170B respectively, first and second third party service providers 170C and 170D respectively, and a user (guest) 170E. Also connected to the Network 100 are first and second Guest Event Providers 175A and 175B respectively, first and second organizations 175C and 175D respectively, and a government entity 175E. Also depicted are first and second servers 190A and 190B may host according to embodiments of the inventions multiple services associated with a provider of contact management systems and contact management applications/platforms (OGL-SAPs); a provider of a SOCNET or Social Media (SOME) exploiting OGL-SAP features; a provider of a SOCNET and/or SOME not exploiting OGL-SAP features; a provider of services to PEDS and/or FEDS; a provider of one or more aspects of wired and/or wireless communications; an Guest Event Provider 160 such as Multiple Listing Service (MLS) exploiting OGL-SAP features; license databases; content databases; image databases; content libraries; customer databases; websites; and software applications for download to or access by FEDs and/or PEDs exploiting and/or hosting OGL-SAP features. First and second primary content servers 190A and 190B may also host for example other Internet services such as a search engine, financial services, third party applications and other Internet based services.

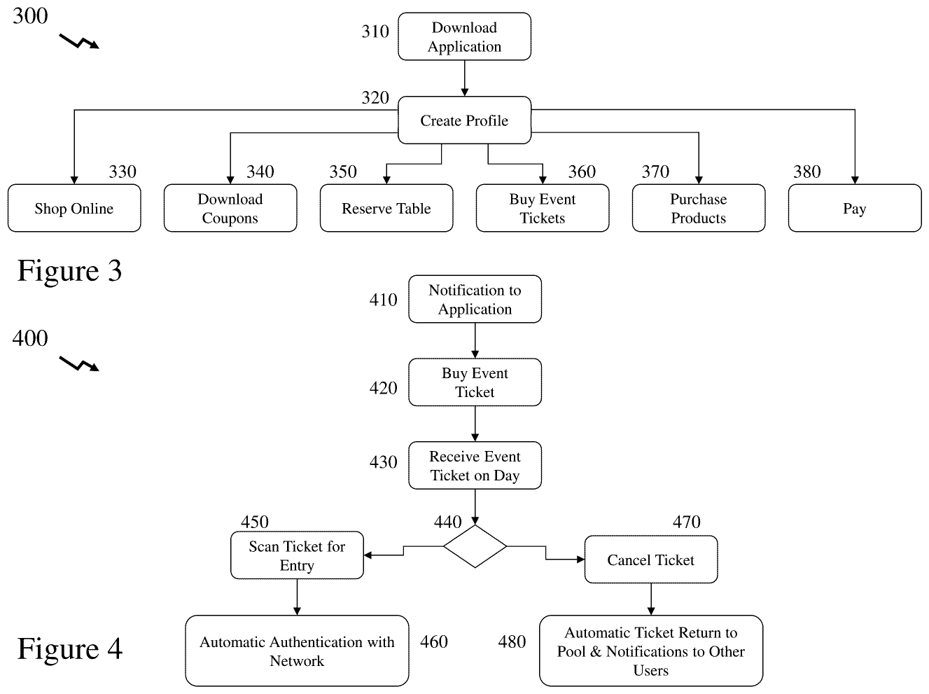

Also depicted in FIG. 1 are Electronic Devices (EDs) 100 according to embodiments of the invention such as described and depicted below in respect of FIGS. 3A to XXX. As depicted in FIG. 1 the EDs 100 communicate directly to the Network 100. The EDs 100 may communicate to the Network 100 through one or more wireless or wired interfaces included those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, a user/guest may exploit a PED and/or FED within a Guest Event Provider 160, for example, and access one of the first or second primary content servers 190A and 190B respectively to perform an operation such as accessing/downloading an application which provides OGL-SAP features according to embodiments of the invention; execute an application already installed providing OGL-SAP features; execute a web based application providing OGL-SAP features; or access content. Similarly, a guest may undertake such actions or others exploiting embodiments of the invention exploiting a PED or FED within first and second user groups 100A and 100B respectively via one of first and second cellular APs 195A and 195B respectively and first Wi-Fi nodes 110A. It would also be evident that a guest may, via exploiting Network 100 communicate via telephone, fax, email, SMS, social media, etc.

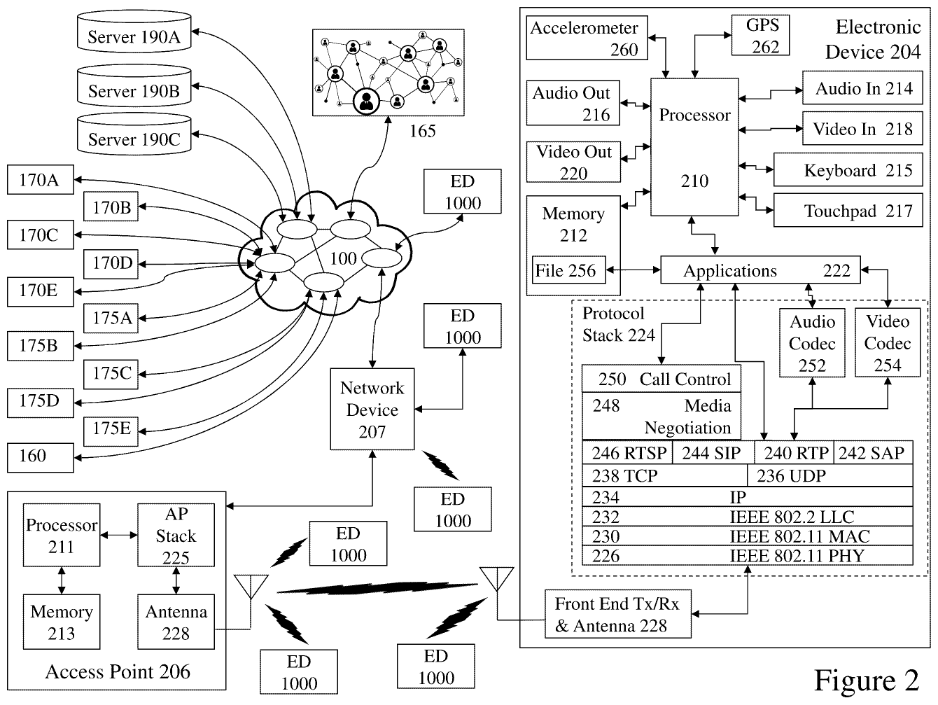

Now referring to FIG. 2 there is depicted an Electronic Device 204 and network access point 207 supporting OGL-SAP features according to embodiments of the invention. Electronic Device 204 may, for example, be a PED and/or FED and may include additional elements above and beyond those described and depicted. Also depicted within the Electronic Device 204 is the protocol architecture as part of a simplified functional diagram of a system 200 that includes an Electronic Device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to Network 100 and therein Social Networks (SOCNETS) 165, first and second service providers 170A and 170B respectively, first and second third party service providers 170C and 170D respectively, a user 170E, first and second Guest Event Providers 175A and 175B respectively, first and second organizations 175C and 175D respectively, and a government entity 175E.

The Electronic Device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an audio output element 216, for example, a speaker, coupled to any of processors 210. Electronic Device 204 may include a video input element 218, for example, a video camera or camera, and a video output element 220, for example an LCD display, coupled to any of processors 210. Electronic Device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Electronic Device 204. The one or more applications 222 that are typically stored in memory 212 and are executable by any combination of processors 210. Electronic Device 204 also includes accelerometer 260 providing three-dimensional motion input to the process 210 and GPS 262 which provides geographical location information to processor 210.

Electronic Device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the Electronic Device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by Electronic Device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted in FIG. 2 are Electronic Devices (EDs) 100 according to embodiments of the invention such as described and depicted below in respect of FIGS. 3A to XXX. As depicted in FIG. 2 an EDs 100 may communicate directly to the Network 100. Other EDs 100 may communicate to the Network Device 207, Access Point 206, and Electronic Device 204. Some EDs 100 may communicate to other EDs 100 directly. Within FIG. 2 the EDs 100 coupled to the Network 100 and Network Device 207 communicate via wired interfaces. The EDs 100 coupled to the Access Point 206 and Electronic Device 204 communicate via wireless interfaces. Each ED 100 may communicate to another electronic device, e.g. Access Point 206, Electronic Device 204 and Network Device 207, or a network, e.g. Network 100. Each ED 100 may support one or more wireless or wired interfaces including those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED, wherein one or more parties including, but not limited to, a user, users, a Guest Event Provider, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the Network 100 using the electronic device or within either the access point 206 or network device 207 wherein details of the transaction are then coupled to the Network 100 and stored within remote servers.

Optionally, rather than wired and/or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH) etc.

An OGL-SAP according to embodiments of the invention facilitates the capture of customer data from every guest registered with the OGL-SAP allowing for the compilation of a more detailed guest profile (profile) with which to enhance service provisioning within the OGL-SAP.

An OGL-SAP according to embodiments of the invention facilitates the purchasing of products and/or services during an event by a guest in real time without staff intervention and/or requiring that the guest be at a specific location within the event.

An OGL-SAP according to embodiments of the invention facilitates purchasing of goods and/or services by leveraging biometric authentication upon the guest's PED and/or multi-factor authentication can remove the requirements and/or potential security issues with respect to financial instruments such as credit cards and debit cards that exploit “tap” interfaces, e.g. near-field wireless communications.

An OGL-SAP according to embodiments of the invention facilitates exploitation of the OGL-SAP by an event provider for all events so that it can migrate existing retail functions to the OGL-SAP and handle special events etc.

An OGL-SAP according to embodiments of the invention can mitigate or reduce issues for an event provider including, but not limited to,
end of day bookkeeping including, but not limited to, busy events, large events;
reduction in theft of cash, product, raw materials etc. and mishandling orders;
problems providing superior customer service during high guest volume periods or large events;
costs for front of house staffing;
focusing core staff to key functions rather than them being high-priced order takers;
obtaining accurate and real time sales reporting; and
scalability with event size, duration, ebb-and-flow of guests, etc.
strict menus etc. allowing Scalable and easily deployable

An OGL-SAP according to embodiments of the invention can allow an event provider to provide customized menus to guests, guest specific marketing, guest specific promotions.

An OGL-SAP according to embodiments of the invention can enable real time contact with customer through single portal rather than multiple software applications, verbal instructions, etc.

With respect to the event producer and guest an OGL-SAP according to embodiments of the invention provides for managing that all customers are guests and are all very unique, with each guest having their own very specific wants and needs. The OGL-SAP provides for each customer to establish and maintain their own unique identity when visiting an event venue and feel like they got exactly what they came for. Guests experience a heightened level of service as messaging is direct to them without delays through staff etc. and can be modified based upon the guest's profile within an overall OGL-SAP itself and/or as associated with a specific event or event venue for example.

An OGL-SAP according to embodiments of the invention can allow event venue owners and/or event managers to provide high quality service in a fast and efficient manner. Everything a customer needs to know about the event will be in the palm of their hands, giving them the feeling of complete control during their time within the event. Further, enhanced customization and integration to third party services and/or applications allows for improved customer engagement, knowledge and satisfaction. By leveraging the guest's PED an OGL-SAP places a highly effective powerful event centric sales tool into the hands of their customers. Further, the OGL-SAP can leverage the guest's PED to trigger actions and activities.

An OGL-SAP according to embodiments of the invention can also allow improved efficiency to event staff as routine customer activities are offloaded allowing the event front of house staff to process more orders with improved accuracy meaning increased business, fewer servers or both.

An OGL-SAP according to embodiments of the invention can also increase business efficacy while diminishing operating costs as previous activities requiring higher skill labour or where higher skilled labour was employed in appropriately to be reduced or eliminated by reducing the requirements to anyone with the appropriate certification/skills. For example, in Ontario the provisioning of food/drink requires that the employee has a SmartServe certificate. Further, processing delays as servers acquire orders, enter them, make errors, forget etc. are removed and the customer gets exactly what they ordered, right or wrong. Further, an OGL-SAP according to embodiments of the invention provides improved communications within the event between different groups of staff as the kitchen orders are updated immediately with the customer's order and variations/amendments accepted within either a predetermined period of time or the customer being advised that their order has been started, finished etc.

It would be evident to one of skill in the art that through an OGL-SAP according to embodiments of the invention guests can visit an establishment and achieve a higher level of service generally. For the vast majority of event venues their cost structures, margins etc. are such that staff are handling multiple functions, supporting potentially large numbers of guests concurrently and being bombarded with questions and information. Accordingly, an OGL-SAP reduces human error and miscommunication which often leads to unsatisfied customers even when the staff are trying their hardest. This dissatisfaction leads to poor online reviews, loss of potential repeat business or unknowingly building a bad reputation. Accordingly, an OGL-SAP according to embodiments of the invention reduces these issues as control, or the prime point of guest interaction, is the guest themselves with their PED. Staff are not required to manage concurrently multiple disparate tasks, worry that they missed something or misunderstood the guest, as the guest generates their order and receives what they ordered every single time. Whilst errors in completing orders may arise the incorrect ordering is now solely at the guest without cause for argument.

Further, an OGL-SAP according to embodiments of the invention removes the requirements for the event venue and the event staff to handle cash, credit cards, tokens, tabs, etc. These are all fully managed through the OGL-SAP itself. Staff no longer can manipulate receipts or bills.

Further, an OGL-SAP according to embodiments of the invention provides the ability for an event venue or event manager to learn, in real time, about the buying patterns and behaviors of their guests. This can allow for modification of menus, adjustments in options presented to users, automated updating of orders from suppliers, and presentation of limited quantities etc. so that a guest knows that what they order will be delivered rather than being told a period of time after ordering it is unavailable and now their order is out of step with others in their group. Further, an OGL-SAP according to embodiments of the invention allows a group to all order at the same time but manage their own payment removing the splitting of a bill, the arguments over who had what etc.

Now referring to FIG. 3 there is depicted an exemplary Flow 300 for an omnichannel system according to an embodiment of the invention. The description is written with respect to a user being able to perform actions wherein once they have attended an event of an event venue/event provider then they become a guest of that event venue/event provider. A user may have the ability to allow their profile data to be accessible to any event location/event provider or they may block it or selectively allow. For example, as describe below a user may elect that a preferred taxi service be indicated to all events but may wish to limit their purchasing history as discrete to each event, event location. Hence, for example, without profile sharing vegetarian options and non-vegetarian options may appear on the food menu for each event whereas the user with profile sharing may prevent this as they do not wish to order non-vegetarian for example. The same may be true with drink options, merchandise options, etc. However, whilst specific categories of food, drink etc. may be shared or limited other aspects of the user profile may be automatically shared such as allergy information. User permission for such sharing being provided within the OGL-SAP by the user when initially established, when they wish to amend it or when being asked with the addition of a new event and/or event location.

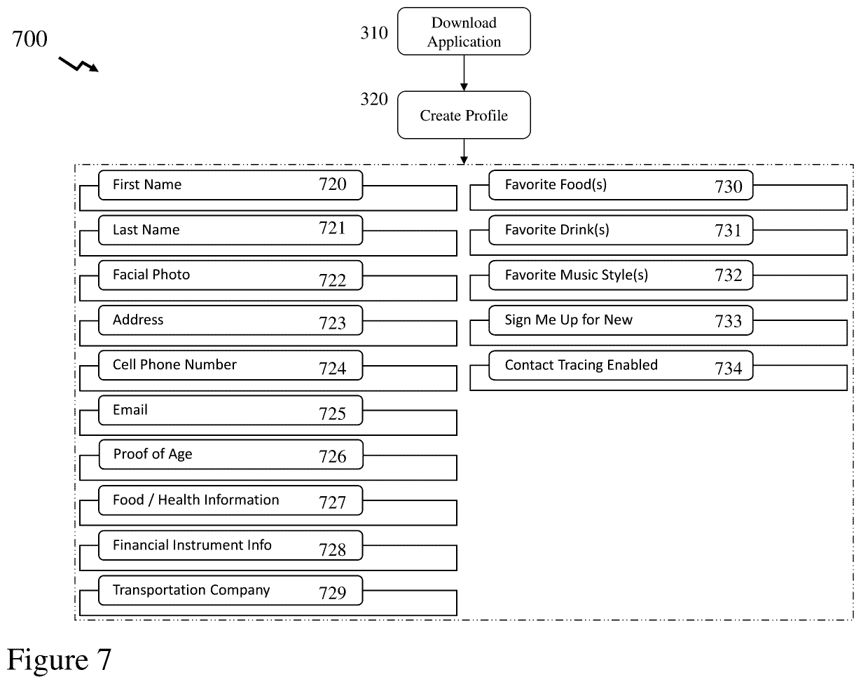

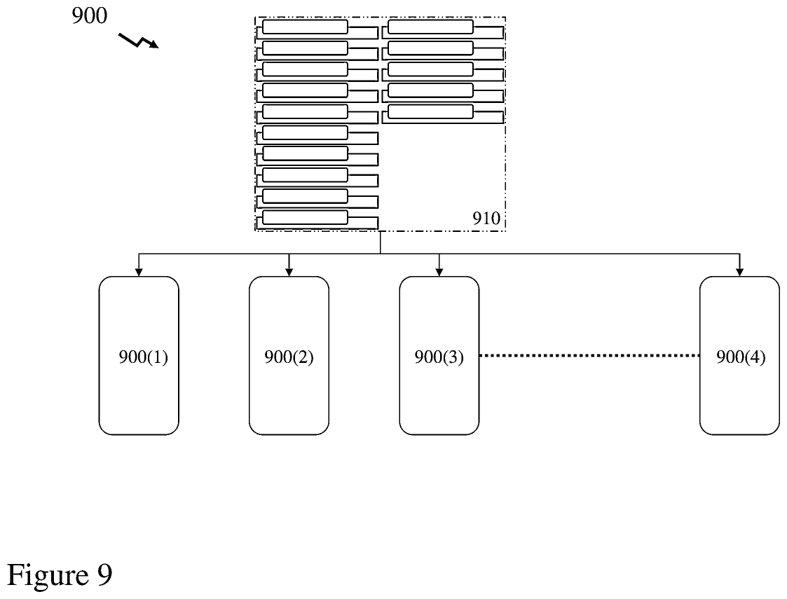

As depicted Flow 300 comprises first to eighth steps 310 to 380 respectively, these being:
First step 310 wherein a user, who may subsequently become a guest, downloads an OGL-SAP application to their electronic device, whilst it is envisaged throughout the following description that the guest's electronic device is a PED it would be evident that not all aspects of embodiments of the invention are not limited to those employing a PED.
Second step 320 wherein the user creates a profile comprising information such as that depicted and described below in respect of FIG. 7. However, it would be evident that this initial profile may have multiple other profiles associated with it such as described and depicted in respect of FIG. 9.
Third step 330 wherein a user can shop through the OGL-SAP.
Fourth step 340 wherein a user can download coupons through the OGL-SAP to redeem with respect to products, services, events etc.
Fifth step 350 wherein a user can reserve a table for a venue.
Sixth step 360 wherein a user can buy tickets to an event, either an event which is discrete with multiple event venues providing services and/or products, e.g. Ottawa BluesFest, or an event associated with a specific event venue, e.g. a band “The Northern Pikes” at the Overflow Brewing Company (hereinafter Overflow).
Seventh step 370 wherein a user can purchase products where these may be specific to the event and/or specific to the event venue or generally. So in the instance above the products may for example include food and drink options normally offered at Overflow, merchandise associated with “The Northern Pikes” and special food/drink options associated with gig.
Eighth step 380 wherein a user pays for purchases made. Within embodiments of the invention a user and/or event may set profile settings for the payment such that, for example, all drinks are paid for when ordered or after several drinks on a “tab.” An event may further establish threshold for a tab so that whilst a guest can “run up” a tab when it hits the threshold it is billed. It would be evident that absent the tab option a user may be limited to committing an order for which funds are actually charged avoiding issues for the event with non-payment.

As an event may facilitate purchase of products and/or services from multiple vendors, e.g. considering the example above this may be those of Overflow as the event venue and “The Northern Pikes”, then the guest can combine multiple items to a single order with single payment, single receipt. Alternatively, within the scenario of a large event such as Ottawa BluesFest with multiple stages, multiple vendors, multiple locations etc. then the guest may have these accessible in a single OGL-SAP as these are onboarded to the event which is then accessed by the user. It would also be evident that as the OGL-SAP can access real time information that the options, menus, products, services, etc. can be updated in real time as well to the user.

Now referring to FIG. 4 there is depicted an exemplary Flow 400 for an event registration portion of an omnichannel system according to an embodiment of the invention. As depicted Flow 400 comprises first to eighth steps 410 to 480 respectively, these comprising:
First step 410 wherein a notification from an event venue and/or event manager is established within an OGL-SAP according to an embodiment of the invention which is then pushed to users of the OGL-SAP whose profile aligns with the event to within a threshold.
Second step 420 wherein the user purchases a ticket to the event associated with the push notification received as a result of first step 410.
Third step 430 wherein the user receives a ticket for the event on the day of the event in the form of a single use machine readable code.
Fourth step 440 wherein the user upon receipt of the event ticket decides to attend the event or not attend the event wherein the process proceeds to fifth step 450 or seventh step 470 respectively.
Fifth step 460 wherein the user is attending the event wherein the ticket in the form of single user machine readable code is acquired by a reader at the event thereby authorizing the user's attendance to the event wherein the process proceeds to sixth step 460.
Sixth step 460 wherein upon authorisation of the entry ticket the user's PED is automatically authenticated with one or more networks associated with the event.
Seventh step 470 wherein the user decides not to attend the event and selects a cancellation option within the OGL-SAP wherein the process proceeds to eighth step 480.
Eighth step 480 wherein the OGL-SAP returns the ticket to the event ticket pool and notifications are pushed to users that a ticket is now available.

For example, using the example above a user of the OGL-SAP may have previously attended Overflow wherein their profile is such that notifications relating to events for Overflow are pushed to them. This profile may as it relates to a brewery/restaurant in Ottawa mean that events relating to other breweries, restaurants may be pushed to them unless the user has initially set a threshold that only want events to match those they have previously registered for, attended etc. A lower threshold set by the user and/or OGL-SAP may result in the other breweries, restaurants etc. being pushed to them until the user defines within the OGL-SAP that do not want to receive notifications for the other event venue, event etc. It would be evident that these thresholds may be established by the user, by the OGL-SAP, established by an AI engine associated with the OGL-SAP, etc. These thresholds may be considered as filters with or without a degree of tolerance. Within other embodiments of the invention an OGL-SAP may be associated with a specific event venue, event, set of event venues, set of events etc.

Within embodiments of the invention the timing between release of the ticket and the event may be different allowing more time for others users to acquire a ticket returned to the ticket pool by a user who subsequently decides not to attend.

Within other embodiments of the invention other users may offer a premium to be notified first of returning tickets having failed to purchase one initially. However, in this instance the excess value paid by the user is distributed to the event venue and/or event rather than to another user who resells the ticket. Within embodiments of the invention the machine readable code may encrypt an identity of the PED the user purchased the ticket upon which is validated when the machine readable code is acquired thereby preventing the ticket being resold and/or passed to another individual.

Optionally, a user may purchase multiple tickets but must provide the electronic addresses of the other users for whom the tickets are intend for wherein the OGL-SAP contacts each advising them that a ticket has been purchased and requiring confirmation through the OGL-SAP application on their PED allowing the machine readable code for the one time use to be generated and encrypted with the identities of their PEDs which are acquired by the OGL-SAP when the other users confirm. Optionally, the one-time code for other users when a user purchases multiples may be provided to the user in a series of emails/SMS messages or other electronic means such that the user forwards a one-time code discretely to one user they wish to invite. In this manner, each other user receives only a single code.

Within embodiments of the invention upon validation of a one-time code upon presentation by a user the OGL-SAP may trigger automatic network authentication of the user to a wireless network or networks associated with the event and/or event venue. This authentication being by provisioning of an access code to the wireless network to the PED which is then used by an OGL-SAP in execution upon the user's PED to associate with the wireless network where the access code is presented during the authentication, such as through a combination of Wired Equivalent Protocol (WEP) and IEEE 802.1x thereby allowing the wireless network to automatically generate session-specific and dynamic encryption keys with rotating WEP keys. Accordingly, a user's authentication with the network is only valid for that specific session for that user and/or user's PED.

Optionally, a machine readable code comprising a one-time use access token may be generated and presented to the user's PED when the user's one time code for the ticket is acquired/validated. The benefit of wireless techniques being that they can be performed once the user passes the access point rather than potentially slowing entry through the need to acquire the one-time code for the ticket, validate, generate the one-time access token, render upon a display and have the user acquire. However, within embodiments of the OGL-SAP this may be performed in real time without significant delay to user entry.

Accordingly, to the nature of information being exchanged then it may be appropriate for a Wi-Fi Protected Access protocol such as WPA2 or WPA3 to be employed. For example, if financial transactions are routed through the event network enhanced security may be appropriate rather than the scenario where the user orders, the event systems prompt the user to select a payment means with an order code, the payment is completed by the user through a financial application for their financial institution where the user includes the order code and the event is then notified of the payment from the institution with the order code which is matched to an order. Other approaches as known in the art may be employed for completing a financial transaction with single factor authentication or multi-factor authentication.

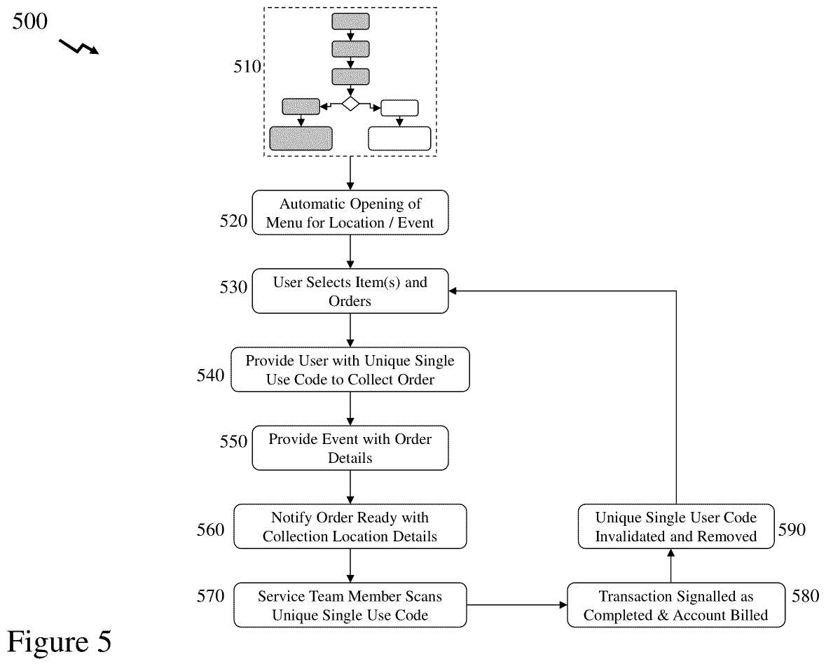

Now referring to FIG. 5 there is depicted an exemplary Flow 500 for item purchasing and collection within an omnichannel system according to an embodiment of the invention. As depicted this Flow 500 comprises a first Sub-Flow 510 together with first to eighth steps 520 to 590 respectively. First Sub-Flow 510 comprising Flow 400 of FIG. 4 wherein a user is presented with an option to purchase an event ticket and attends the event. It would be evident that whilst within embodiments of the invention the reader may consider that an event is a specific one off event it should be understood that the event is intended to mean any scheduled activity associated with the event venue.

Accordingly, an event may be a brunch at a restaurant with a fixed number of diners for a fixed window, e.g. 10 am-noon, or it may be a concert, dinner, breakfast, tasting session etc. Essentially, an event should be construed to mean an activity with a defined number of guests within a defined period of time. Accordingly, a restaurant may employ the OGL-SAP to schedule diners for its regular evening dinners. Diners may though the OGL-SAP see that the restaurant is fully booked but be notified of a no-show allowing them to acquire these unused reservations. As such a ticket may have no specific transactional value or monetary value unlike a ticket for a concert, race, sporting event etc. but defines the user's ability to attend the event. It would be evident that, for example, a brewery may have a capacity within its restaurant/bar area of N people and that by issuing tickets it can verify that it does not exceed its legal capacity. Further, a user with the OGL-SAP may through being “registered” with multiple event venues can see that a specific bar has capacity for them this evening and register thereby ensuring they can be served rather than attending to find it at capacity. A venue may also, therefore, return tickets itself upon guests departing or the guest not turning up rather than the user cancelling their ticket. Accordingly, a venue can dynamically publish ticket availability as guests attend and depart during the course of a day, evening, afternoon, etc.

Once the user has attended the event and is registered with the wireless network then first to eighth steps 520 to 590 are executed, these comprising:
First step 520 wherein a menu relating to the event/location is automatically provisioned to the user/guest upon their PED.
Second step 530 wherein the guest selects the item(s) they want and orders.
Third step 540 wherein the user is provided with a single use code to collect their order.
Fourth step 550 wherein the OGL-SAP advises the event of the order details.
Fifth step 560 wherein the order is processed and the guest is notified that the order is ready and provided with the collection location details.
Sixth step 570 wherein the guest goes to the location.
Seventh step 580 wherein the guest presents their unique single use code which is scanned by a service team member thereby advising them of what order the guest is collecting. This can, optionally, also provide personal information so that the service team member can use the guest's name to increase a level of personal engagement.
Eighth step 590 wherein the unique single use code is invalidated and removed from the OGL-SAP upon the guest's PED and the process loops.

It would be evident that alternate flows to Flow 500 may allow a user to generate one or more other orders each with a unique single use code before collecting another order. Further, the notifications may be based upon fulfillment rather than the order the guest generates them. Optionally, a user can align orders to reduce trips such that two orders generated within a threshold period of time are serviced by the same location.

Optionally, within another embodiment of the invention the user may present the unique one time code to a reader at the service location and be advised of which “bin” to retrieve it from whereby the “bin” scans the unique one time code to open. In this manner, for example, a retailer may provide a pick-up service without the requirement for the guest to interact with employee(s) but be confident that their order is secure until they collect it. Alternatively, the user is advised of the “bin” identifier upon notification to pick up their order.

It would be evident that steps within Flow 500 may be varied without departing from the scope of the method presented. For example, seventh step 580 may be immediately after second step 530 such that the user is only provided with a one-time use code once their order has been paid for. Alternatively, this may be thresholded such that a user can establish a tab and orders processed until their tab limit reached wherein the guest must pay their tab before further orders can be established. This may be preferable where the event wishes to minimize the number of financial transactions as it is required to pay a fee per transaction. As such this threshold may be varied according to the financial instrument the guest denotes that they will pay for the order with.

An OIGL-SAP according to an embodiment of the invention may present, as an alternate embodiment for fifth step 560, the guest with a notification that their order is complete and that it will be delivered to them. This may include, for example, additional information such as the identity of the server delivering the order to increase guest engagement with the server for example. However, the process described within Flow 500 may describe scenarios with large events with multiple locations provisioning the products/services. For example, at a large event the location established for the fulfillment of the order may be established based upon the guest's location so that the fulfillment is that closest to them or it may be selected based upon lowest fulfillment processing time with or without a threshold for distance/travel time.

Within other embodiments of the invention the OGL-SAP may select the location rather than the provider of the product/service. For example, a guest may simply want at a large event a burger, fries and a bottle of water without preference of provider wherein the OGL-SAP will select the nearest and/or fastest provider of that order to fulfill it and provide that location information to the user.

Within other embodiments of the invention the OGL-SAP may select the location based upon that location having the shortest queue to collect an order with or without a threshold for distance/travel time and then notify that location of the order it is to fulfill and then the guest. In this manner, for example, at an event with multiple locations providing the same product, e.g. a beer at a football match, the user is directed to the location with the shortest queue where the queue is based upon the OGL-SAP knowing which guests it has directed to each location and based upon the scanning of their unique one time codes which have collected their order. In this manner the OGL-SAP can dynamically allocate guests to locations whereby real time order fulfillment issues that slow a location are accommodated automatically without any server or other individual notifying of an issue.

An OIGL-SAP according to an embodiment of the invention may present a customized menu to the user based upon a standard menu which is then filtered based upon preferences of the user accessible to the OGL-SAP from the user's profile. As noted above an OGL-SAP may provide the guest with an ability to set preferences for an event(s)/location(s) which are applied such as vegetarian/non-vegetarian, gluten free/non-gluten free, etc. These may be presented as standard buttons within a GUI rendered to the user such that these toggle to one option of the other allowing the user to make these filtering options applied to that event, e.g. they may wish to select vegetarian for this event having selected non-vegetarian within a prior event or vice-versa. Other filters and/or modifiers may be automatically applied such as those relating to allergies of the user such that options with constituents the guest is allergic to are not presented or options are pre-selected to comply with the allergy restrictions. For example, a lactose allergy may mean that an order for coffee with milk is automatically set to a dairy free option or if more than one is available only the non-dairy options are provided.

Within the embodiment of the invention described and presented with respect to FIG. 5 the order is provisioned to the guest at the event during the event. However, it would be evident that the order may include items for delivery post-event including products/services available during the event as well as others not available during the event. Examples of such options are described elsewhere within this specification.

An OIGL-SAP according to an embodiment of the invention may further provide menu options based upon real time availability. For example, a restaurant may have a fixed number of portions of an item such that once these have been ordered this item is automatically filtered from the menus presented to subsequent guests removing the issue of guest disappointment that an item they want is now no longer acceptable. As outlined below in respect of other merchandise where this may be delivered to the guest after the event the options may be presented not on immediate availability but on delivery time. For example, a guest seeking to buy a “Northern Pikes” shirt, where the system knows the user is male and an extra-large (XL) may be advised that an XL t-shirt can be delivered tomorrow but that an XL sweatshirt will take 3 days and an XL hoodie 2 weeks. Accordingly, the guest can made purchasing decisions without disappointment as they are provided with the information prior to purchase and the event may still make sales knowing that the products sold are currently not immediately available for delivery.

An OIGL-SAP according to an embodiment of the invention may provide a guest with a cancellation option where the cancellation option is available for a period of time. This period of time may be established in dependence upon, for example, an aspect of the product(s) ordered, a projected fulfillment time, a project cost of having to throw the part prepared product away, etc. For example, an order for an item with long preparation time may have a short cancellation window as the preparation of the item will be started quickly whereas an item with shorter preparation time will be started later in view of currently pending orders. For example, an order for a burger within a brewery may have a high probability of being ordered quickly by another guest if a guest cancels such the likely cost of waste is lower so a longer cancellation window can be provided than perhaps for an order of fish and chips for example. Similarly, cancellation of items pre-packaged/sealed etc. may be much longer than those that are freshly prepared.

Optionally, within embodiments of the invention a notification is provided that the order has been completed at the location of collection.

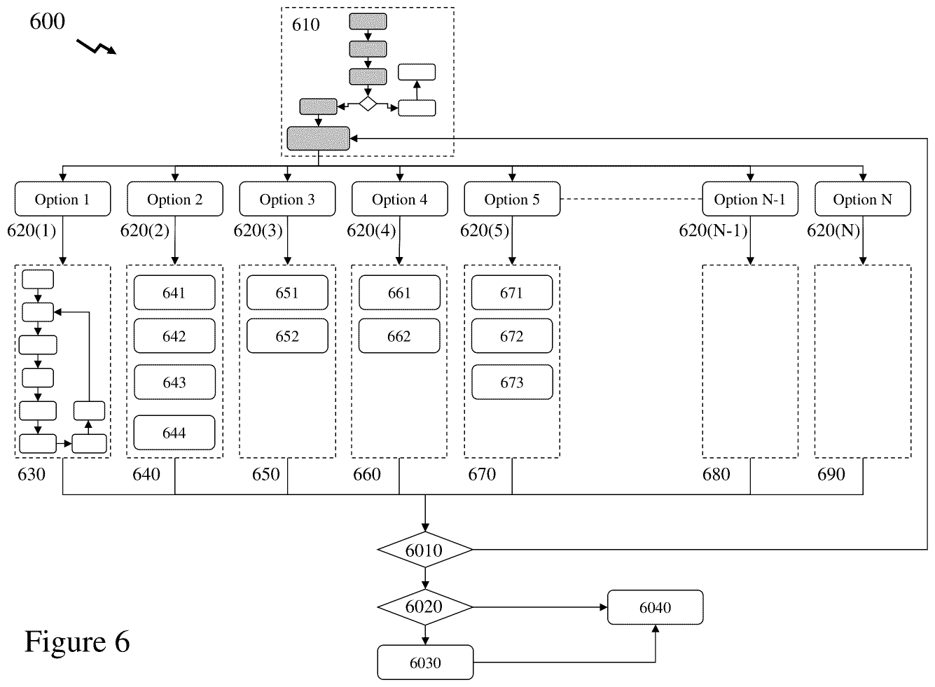

Now referring to FIG. 6 there is depicted an exemplary Flow 600 for an omnichannel system according to an embodiment of the invention. As depicted Flow 600 comprises first Sub-Flow 610, first to N Option Selections 620(1) to 620(N) respectively and first to N Option Flows 630, 640, 650, 660, 670, 680 and 690 respectively together with first to fourth steps 6010 to 6040 respectively. First Sub-Flow 510 comprising Flow 400 of FIG. 4 wherein a user is presented with an option to purchase an event ticket and attends the event. Once the user has “entered” the event by having the unique one time code for their ticket processed then a GUI of the OGL-SAP on their PED presents a series of options, represented by first to N options 620(1) to 620(N) respectively.

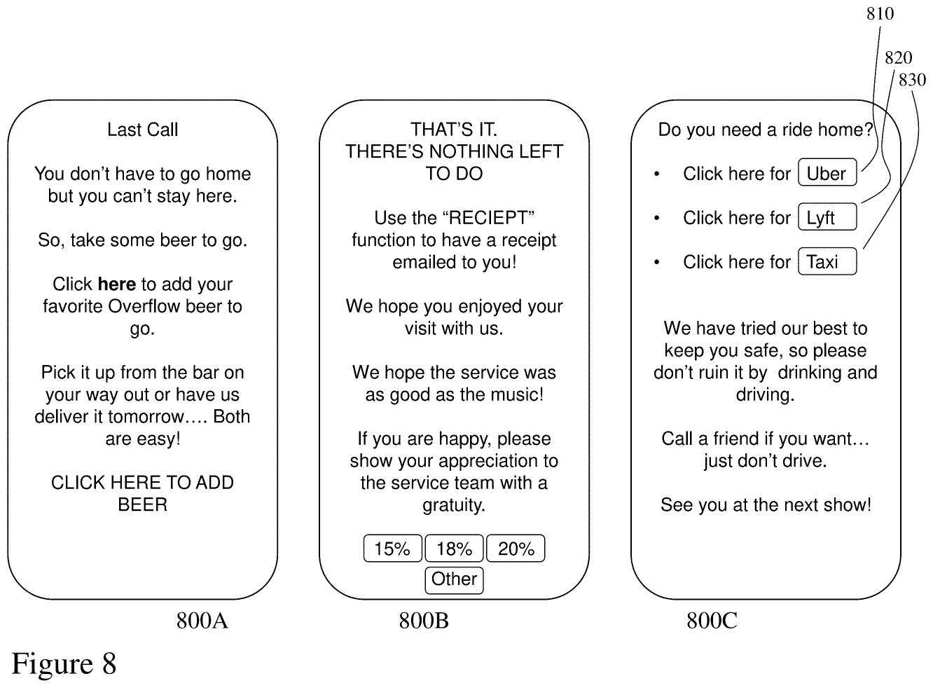

Based upon selection of an option of first to N Option Selections 620(1) to 620(N) respectively then the OGL-SAP proceeds to the associated option flow of first to N Option Flows 630, 640, 650, 660, 670, 680 and 690 respectively. Upon completion of the selected option of first to N Option Selections 620(1) to 620(N) respectively the OGL-SAP determines in first step 6010 whether the guest is leaving the event and/or event is terminating. If the determination to either is negative then Flow 600 loops back, which for simplicity is depicted to first Sub-Flow 610 although it may be to an intermediate process step which re-renders the GUI without requirement for any of the steps of first Sub-Flow 600A. If the determination in first step 6010 is positive then Flow 600 proceeds to second step 6020 wherein the OGL-SAP determines whether any final product and/or service is required or not wherein a positive determination leads to the execution of third step 6030 before Flow 600 terminates at fourth step 6040 otherwise Flow 600 proceeds immediately to fourth step 6040. Examples of options within third step 6030 are described and depicted with respect to FIG. 8.

Considering Option 1, selected by first Option Selection 620(1) leading to Option Flow 630 then this corresponds to a process flow for a guest ordering products/services associated with an event such as described and depicted with respect to Flow 500 in FIG. 5. Accordingly, a guest is able to purchase products and/or services associated with the event venue and/or event. Whilst Flow 500 was described within a presented event of a concert at a brewery it would be evident the method/processes described apply to any retail environment such that a guest can purchase a television within a retailer whilst standing in front of it and be advised when the television is ready to be picked up or a guest can purchase clothing whilst browsing to be advised when it is packaged and ready for them to take away. It would be evident that these concepts may apply to single retail location and retailer as well as to a single retail location, e.g. a shopping mall, with multiple retail locations etc. such that the orders made by the guest at multiple retailers are provided to a single collection location, e.g. customer service desk within the shopping mall or loading area, and the guest can collect them all at the same time upon presentation of the one-time use code(s) associated with the order(s). As noted, the Flow 500 can be repeated multiple times sequentially, in parallel, concurrently etc.

Considering Option 2, selected by second Option Selection 620(2) leading to second Option Flow 640 then a guest is able to access additional information relating to the event that they are attending. For example, considering the exemplary scenario above then in Option Flow 640 the guest is attending the event of “The Northern Pikes” playing at the Overflow brewery. Within Option Flow 640 the guest is able to access additional options relating to the event such as first to fourth Sub-Options 641 to 644 as depicted. These comprising within this exemplary scenario:
First Sub-Option 641 wherein the guest is able to access biographical information and associated information relating to an activity at that point in time, e.g. a background story to the song currently being played. First Sub0-Option 641 may be constant for the entire event or it may be contextually defined such as guest location, current event activity, etc.
Second Sub-Option 642 wherein the guest is able to select acquisition of an item based upon a current context of the event, e.g. the guest can add a current song to a playlist accessible to the guest for playing during a subsequent predetermined period of time, e.g. 1 hour, 2 hours, 1 day etc. Within other contexts rather than adding a song to a playlist the addition may be a uniform resource locator (URL) associated with an item established by the user scanning a machine readable code on the product so that they can subsequently view immediately without additional searching or having to remember what it was and where it was. Such URLs may be added to a browser of the user's PED by the OGL-SAP for example or the playlist added to a music player of the user's PED by the OGL-SAP. In this manner, guest defined additional elements can be captured and provide options for subsequent retail actions of the guest post-event, e.g. buying the track, product etc. Further, the OGL-SAP acquires customer specific data as know data relating to the guest is established relating to elements not immediately purchased. So within the example of the event for “The Northern Pikes” a series of new tracks may be assessed based upon how many guests add each to their playlists or a retailer may define that a large number of guests scan a particular item but that the number of sales is low implying customer appreciation of the product but at an unacceptable price point.
Third Sub-Option 643 wherein the user elects to purchase an item presented to them, e.g. the item for which they scanned the tag, added to their playlist, etc. so that a sale transaction is performed for this item during or after the event.
Fourth Sub-Option 644 wherein the user having acquired data relating to an aspect of the event, e.g. the URL of a product they scanned the machine readable code for or selecting a track for a playlist, can share this with others via one or more of the guest's social media channels wherein the OGL-SAP captures the sharing for additional analytical activities relating to products, gust decisions, etc.

Considering Option 3, selected by third Option Selection 620(3) leading to third Option Flow 650 wherein the guest is presented with options specific to that specific event rather than the event generally and/or event venue generally. For example, using the exemplary scenario again the guest can view merchandise associated with the specific event, i.e. the band “The Northern Pikes”, rather than the venue, Overflow, although within other embodiments of the invention the guest may always be presented with the venue merchandise and then specific other merchandise added for specific events. Accordingly, in this scenario the guest is presented with both venue merchandise and band merchandise such as records, t-shirts, shirts, hats, glasses etc. These items can be purchased and the guest in fifth Sub-Option 651 the option of collecting these at the event wherein a unique one time use code is generated as with first Option Flow 630 or in sixth Sub-Option 652 the guest is provided with the option of having them shipped to a selected location, e.g. their your home the next day, thereby eliminating the need for the guest to carry anything during the event and/or where the items are fragile reducing likelihood of the guest breaking their purchase.

Considering Option 4, selected by fourth Option Selection 620(4) leading to fourth Option Flow 660 wherein one or more options relating to the event can be provided allowing direct within event interaction on non-transaction aspects. For example, the guest in seventh Sub-Option 661 may be able to interact with the event such as, in the exemplary scenario, a band that takes requests by messaging them in real time from the OGL-SAP or alternatively within eighth Sub-Option 662 the guest is able to notify the event of an issue quickly and easily, such as a faulty washroom, broken chair, etc.

Considering Option 5, selected by fifth Option Selection 620(5) leading to fifth Option Flow 670 then the guest may be provided with specific options upon their exit from the event and/or the termination of the event. For example, within the exemplary scenario and with reference to FIG. 8 then the user is presented with ninth to eleventh Sub-Options 671 to 673 respectively which are identified, for example, as three GUI elements “Last Call”, “Gratuity” and “Taxi.” “Last Call” for example only being described at a predetermined point in time with respect to the event whereas “Gratuity” and “Taxi” are provided under both scenarios.

Accordingly, selection of GUI element “Last Call” triggers first GUI 800A in FIG. 8 and ninth Sub-Option 671 wherein the guest is advised that it is “last call” for purchasing a product or items within a category of product to comply with the regulatory restrictions on the event. For example, within the exemplary scenario Overflow can only see alcohol to a predetermined time and/or guests can only take home “carry out” purchased before this predetermined time, e.g. 11 pm.

Accordingly, the first GUI 800A provides the option for the guest to purchase “carry out” wherein as they progress through this they are provided with the option of taking it then or having it delivered. Whilst a final order for consumption within the event could be handled through this sub-flow it can also be handled by routing the guest to first Option Flow 630 such that fifth Option Flow 670 is solely relating to carry out or next day delivery sales. Optionally, this option may automatically default to any order placed after this defined time being shipped to the customer.

Accordingly, selection of GUI element “Gratuity” triggers second GUI 800B in FIG. 8 and ninth Sub-Option 672 wherein the user has the option of providing a gratuity. Optionally, if the guest runs a tab all through the event then the gratuity is applied to that single final payment. As depicted the guest is presented with defaults and an option to define the gratuity themselves.

However, if the guest has paid multiple times through the event then this option allows a gratuity to be calculated across all these orders and paid rather than the user selecting a gratuity per transaction and may be optionally notified that as they exit the event they will be provided with the option to make a single gratuity payment at the end to reflect their overall experience etc. Optionally, upon completion of the gratuity the guest may be automatically directed to third GUI 800C in FIG. 8 as described below or the OGL-SAP may loop back.

Selection of GUI element “Taxi” triggers third GUI 800C in FIG. 8 and ninth Sub-Option 673 within FIG. 6 wherein a user is provided with the option of selecting a ride option home. As depicted within third GUI 800C the guest is provided with first to third Ride Options 810 to 830 labelled Uber™, Lyft™ and “Taxi.” The first and second Ride Options 810 and 820 may be determined by the OGL-SAP on the guest's PED determining that the guest has the applications for these services on its PED and hence selection of these options opens the respective applications to allow the guest to use their regular service. Alternatively, third Ride Option 830 is a call to a default taxi service established by the event.

Considering Option N−1, selected by N−1 Option Selection 620(N−1) leading to sixth Option Flow 680 then this may, for example, allow the guest to provide direct feedback on one or more SOCNETs or platforms such as Google™, Facebook™, Twitter™, Trip Advisor™, etc. The SOCNETs/platforms may, for example, be determined by the OGL-SAP establishing what applications are installed on the guest's PED and/or by the event.

Considering Option N, selected by N Option Selection 620(N) leading to seventh Option Flow 690 then this may present other options to the guest. Accordingly, it would be evident that an OIGL-SAP according to an embodiment of the invention may provide multiple options within it for a user to interact with and/or engage with the event. Which options presented within the OGL-SAP may vary according to one or more factors including, but not limited, preferences defined by the event, guest, location, time, date, etc.

FIG. 7 there is depicted an exemplary guest Flow 700 for an exemplary registration process for an OGL-SAP according to an embodiment of the invention. As depicted first and second Steps 310 and 320 correspond to their equivalent steps in FIG. 3. Once the user has selected to create their profile then they are guided through a series of GUIs which allow the user to enter a range of information relating to themselves, their preferences etc. Accordingly, for example, as depicted in FIG. 7 the user enters first to ninth Fields 720 to 729 respectively and tenth to fourteenth Fields 730 to 734 respectively. For first to ninth Fields 720 to 729 these may, for example as depicted represent:
First name 720;
Last name 721;
Facial photo 722 (which can be used as additional verification for collection/ordering through multi-factor authentication, etc.);
Address 723;
Cellphone number 724;
Email address 725;
Proof of age 726 (e.g. an image of their driver's license or passport for example which is processed by the OGL-SAP to establish their date of birth which is employed in verifying the user can perform age related purchases according to local regulations such as purchasing cigarettes, cannabis, alcohol etc. but may also be employed in additional verification for collection/ordering through multi-factor authentication, etc.);
Food/Health Information 727 wherein the user can enter data relating to allergies, health issues, disabilities, etc. which may be relevant to their attendance at an event;
Financial Instrument Information 728, such as credit card data, debit account data, PayPal™ account data etc.; and
Transportation Company 729, such as a taxi business, friend, family etc. which are not associated with an application installed on the user's PED and the OGL-SAP can identify from the PED.

Tenth to fourteenth Fields 730 to 734 may, for example as depicted represent
Tenth Field 730 identifying one or more favorite foods;
Eleventh Field 731 identifying one or more favorite drinks;
Twelfth Field 732 identifying one or more favorite music styles;
Thirteenth Field 733 wherein the user can elect to sign up for new notifications of event to be pushed to them rather than then searching/identifying etc.; and
Fourteenth Field 734 wherein the user can enable contact tracing.

An OIGL-SAP according to an embodiment of the invention may support contact tracing, such as has become an issue for events with Covid-19, but allowing the user to be contacted in respect of any issue relating to the event arising from an issue such as virus, infection, contaminated product(s), potential contamination(s) etc.

Now referring to FIG. 9 there is depicted an exemplary hierarchy of profiles associated with a guest/user within an omnichannel system according to an embodiment of the invention. As depicted the Hierarchy 900 comprises a Top Level Field Set 910 comprising, for example first to ninth Fields 720 to 729 and tenth to fourteenth Fields 730 to 734 respectively as described and depicted in respect of FIG. 7. Below this Top Level Field Set 910 are first to N Event Field Sets 900(1) to 900(N) respectively which are established in dependence upon the user's actions as a guest at an event. Each of first to N Event Field Sets 900(1) to 900(N) respectively may relate to a single event occurrence. Alternatively, one or more of the first to N Event Field Sets 900(1) to 900(N) respectively may be a compilation of events associated with a single event venue and/or event provider. Accordingly, for example, the exemplary scenario above may result in the OGL-SAP generating a first Event Field Set for the event relating to “The Northern Pikes” and a second Event Field Set for the event location, Overflow, such that subsequent attendances to the same event location are accumulated into the same Event Field Set. In this manner, user preferences for an event location can be established in one instance but user preferences for an event type also established by the OGL-SAP establishing other Event Field Sets such as one for concerts wherein “The Northern Pikes” event is merged with other concerts. In this manner, when the OGL-SAP is opened at a subsequent event it can rapidly retrieve them based upon the event location and event type to provide filter options for the guest.

An OGL-SAP according to an embodiment of the invention allows all customer data to reside in a backend system, e.g. a point-of-sale (POS) system or the OGL-SAP upon the user's PED thereby removing the requirement for the user to carry cash, cards, tokens etc. to an event.

An OGL-SAP according to an embodiment of the invention allows an event venue to configure options for the user and manage everything from an initial entry coat check to drinks, to food, to merchandise, to booking a ride home.

An OGL-SAP according to an embodiment of the invention allows finalizes an order at the point that a Service Team Member scans the unique one time machine readable code wherein the financial transaction is undertaken for that order. This may be completion of payment or a “hold” applied to the financial instrument as known in the art.

An OGL-SAP according to an embodiment of the invention allows issuance of constantly changing machine readable codes, e.g. QR codes, for every single order making it difficult for them to be duplicated, copied or imitated. A machine readable code, e.g. QR code, may contain seed data that can only be run through an authentication algorithm so even if a photograph of a visual machine readable code, e.g. QR code, is taken then it can only be used once by the system and then it is discarded forever.

As noted above the OGL-SAP can include within the user profile a profile photo of the user which can be rendered together with the visual machine readable code, e.g. QR code, to provide an additional layer of authentication.

It would be evident that an event could “lock down” a user account in the event the guests PED is lost to reduce the potential for fraudulent transactions.

Machine readable code scanners may within an OGL-SAP according to an embodiment of the invention may be proximity based via radio frequency identification (RFID) with an authentication chip locked to a particular server. In this manner, a scanner will not work if away from a service team member but also the exact individual performing a transaction with the scanner can be logged.

It would be evident that whilst the exemplary scenarios and descriptions with respect embodiments of the invention presented above in respect of FIGS. 3 to 9 have been directed to products that these embodiments of the invention can relate to services or a combination of products and services.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A server comprising:
a processor and a memory, the memory storing executable instructions which when executed by the processor configure the server to:
receive an order from an electronic device via a network to which the server and the electronic device are connected for at least one of a product and a service;
transmit to the electronic device a unique one time machine readable where the unique one time machine readable code is generated by the server in dependence upon the received order;
transmit an authorisation upon successful validation of the unique one time machine readable code being provided to the server from another electronic device which is configured to read machine readable codes where the another electronic device acquires the unique one time machine readable code from the electronic device upon its presentation upon the electronic device by the user to the another electronic device;
automatically terminate the unique one time machine readable code upon successful validation of the unique one time machine readable code; and
execute a financial transaction in dependence upon successful validation of the unique one time machine readable code in dependence upon the at least one of the product and the service associated with the order and financial information provided to the server by the software application; wherein the order is established in dependence upon one or more actions of a user of the electronic device with respect to a real time customized menu rendered to the user by a software application in execution upon the electronic device received from the server where the electronic device transmits the order to the server and where the real time customized menu comprises at least one of a subset of the plurality of products currently available for ordering by the user and a subset of the plurality of services currently available for ordering by the user;
the authorisation is rendered to an individual upon a further electronic device who establishes provisioning of the at least one of the product and the service; and
the real time customized menu is established by a process in execution upon the server comprising:
acquiring a standard menu relating to an event the user is current registered with and attending;
filtering the standard menu to automatically remove products to which the user is allergic where modifications cannot be made in dependence upon a profile of the user provided to the server from the electronic device associated with the user;
modifying options to a subset of the remaining products in dependence upon one or more allergies of the user defined within the profile of the user; and
removing another subset of the remaining to reflect that the product is sold out.

2. A server comprising:
a processor and a memory, the memory storing executable instructions which when executed by the processor configure the server to:
receive an order from an electronic device via a network to which the server and the electronic device are connected for at least one of a product and a service;
transmit to the electronic device a unique one time machine readable where the unique one time machine readable code is generated by the server in dependence upon the received order;
transmit an authorisation upon successful validation of the unique one time machine readable code being provided to the server from another electronic device which is configured to read machine readable codes where the another electronic device acquires the unique one time machine readable code from the electronic device upon its presentation upon the electronic device by the user to the another electronic device;
automatically terminate the unique one time machine readable code upon successful validation of the unique one time machine readable code; and
execute a financial transaction in dependence upon successful validation of the unique one time machine readable code in dependence upon the at least one of the product and the service associated with the order and financial information provided to the server by the software application; wherein
the executable instructions further configure the server to:
automatically establish a provider of the at least one of the product and the service from a set of providers;
transmit a notification to the electronic device for rendering within the software application to the user where the notification indicates:
that the at least one of the product and the service is ready for collection; and
a location for collecting the at least one of the product and the service; and
one of the provider of the set of providers and the location is established in dependence upon a condition being established by the server.

3. The server according to claim 2, wherein
the one of the provider of the set of providers and the location is the provider of the set of providers; and
the condition established by the server is that the provider of the set of providers is the provider of the set of providers nearest to a location of the electronic device associated with the user at one of placement of the order and providing the notification to the user the order is ready for collection.

4. The server according to claim 2, wherein
the one of the provider of the set of providers and the location is the provider of the set of providers; and
the condition established by the server is that the provider of the set of providers is the provider of the set of providers able to complete provisioning of the at least one of the product and the service to the user with a lowest fulfillment processing time of fulfillment processing times for the set of providers.

5. The server according to claim 2, wherein
the one of the provider of the set of providers and the location is the location; and
the condition is that the location of a set of locations is the location of the set of locations with the lowest number of pending orders for collection established in dependence upon the server knowing how many users the server has directed to each location of the set of locations and the number of users that that have had their unique one time machine readable code scanned indicating they have collected their orders.

6. A server comprising:
a processor and a memory, the memory storing executable instructions which when executed by the processor configure the server to:
receive an order from an electronic device via a network to which the server and the electronic device are connected for at least one of a product and a service;
transmit to the electronic device a unique one time machine readable where the unique one time machine readable code is generated by the server in dependence upon the received order;
transmit an authorisation upon successful validation of the unique one time machine readable code being provided to the server from another electronic device which is configured to read machine readable codes where the another electronic device acquires the unique one time machine readable code from the electronic device upon its presentation upon the electronic device by the user to the another electronic device;
automatically terminate the unique one time machine readable code upon successful validation of the unique one time machine readable code; and
execute a financial transaction in dependence upon successful validation of the unique one time machine readable code in dependence upon the at least one of the product and the service associated with the order and financial information provided to the server by the software application; wherein
automatically terminate the unique one time machine readable code upon successful validation of the unique one time machine readable code; and
execute a financial transaction in dependence upon successful validation of the unique one time machine readable code in dependence upon the at least one of the product and the service associated with the order and financial information provided to the server by the software application; wherein
the order for at least one of the product and the service is one of a series of orders placed by the user within a threshold period of time; and
the executable instructions further configure the server to:
provide the user with an option to align the series of orders;
notify the user when the series of orders are available for collection from a location; and
complete the financial transactions upon the successful validation of each code for each order in the series of orders as a single financial transaction.

7. The server according to claim 6, wherein
the executable instructions further configure the server to determine the location from a set of locations based upon the server knowing how many users the server has directed to each location of the set of locations and the number of users that that have had their codes scanned indicating they have collected their orders.

8. The server according to claim 6, wherein
the location is associated with a provider of a set of providers; and
the executable instructions further configure the server to establish the provider of the set of providers is dependence upon determining that the provider of the set of providers is able to complete provisioning of the at least one of the product and the service to the user with a lowest fulfillment processing time of fulfillment processing times for the set of providers.

9. The server according to claim 6, wherein
the location is associated with a provider of a set of providers; and
the executable instructions further configure the server to establish the provider of the set of providers in dependence upon the provider of the set of providers being nearest to a location of an electronic device associated with the user at one of placement of the order and providing a notification to the user the order is ready for collection.
